(19) United States
(12) Patent Application Publication
(10) Pub. No.: US 2015/0222601 A1
(43) Pub. Date: Aug. 6, 2015

(54) Systems for Securing Control and Data Transfer of Smart Camera

(71) Applicants: Maxym Metz, Dnepropetrovisk (UA); Nickolay Bogun, Dnepropetrovsk (UA)

(72) Inventors: Maxym Metz, Dnepropetrovisk (UA); Nickolay Bogun, Dnepropetrovsk (UA)

(73) Assignee: Branto Inc., Mitspe Adi (IL)

(21) Appl. No.: 14/172,964

(22) Filed: Feb. 5, 2014

(51) Int. Cl. H04L 29/06; H04N 1/00

(52) U.S. Cl. CPC H04L 63/04; H04L 63/0853; H04L 63/08; H04N 1/00244; H04N 1/00307; H04N 2201/0084; H04N 2201/0039

(57) ABSTRACT

A system of secure control of a smart camera and transfer a media content from and to smart camera by a user communication device and an intermediate server, comprising: a smart camera, intermediate server and user communication device, which are connected to WAN. The intermediate server includes a SIPS-server, REST API Server, cloud storage, Public Key Infrastructure, private key and server certificate. The smart camera includes a built-in server, a SSD-storage, a client certificate, client private key and an intermediate server public key. The built-in server includes a SIPS-client and REST API Server and the user communication device includes a SIPS-client, a REST Client and a public key of said intermediate server. The smart camera and said user communication devices are connected to common local area networks (LAN) with communicating to wide area network (WAN) or cellular networks.

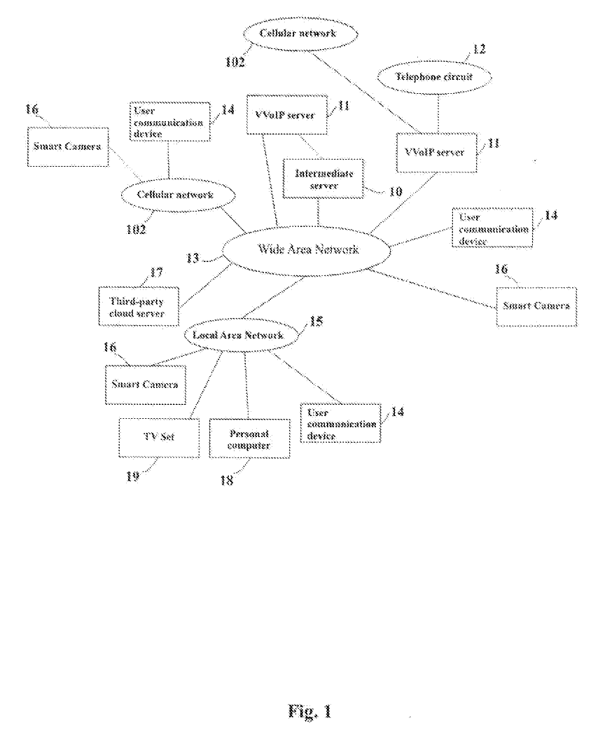

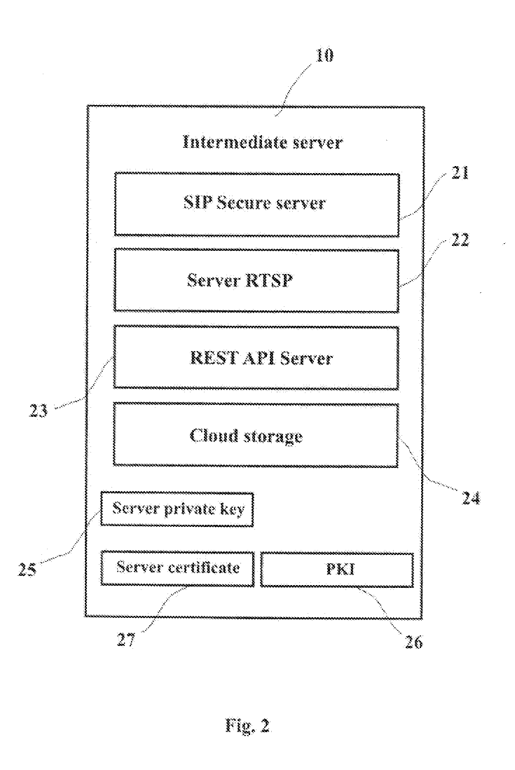

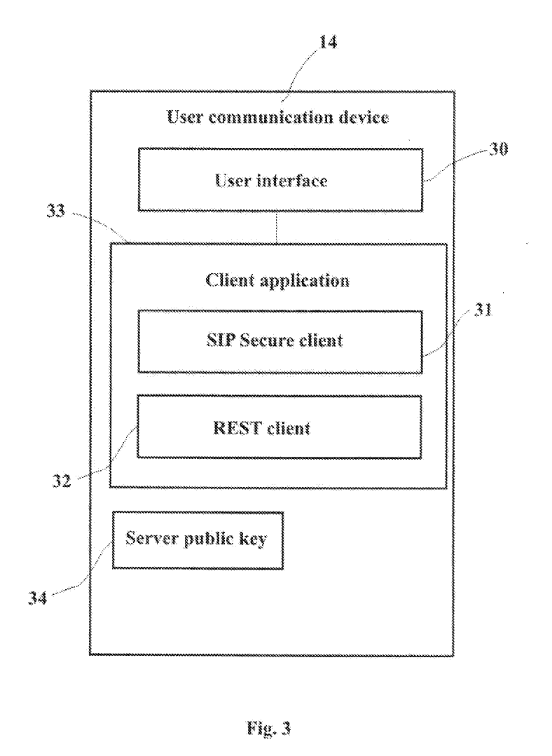

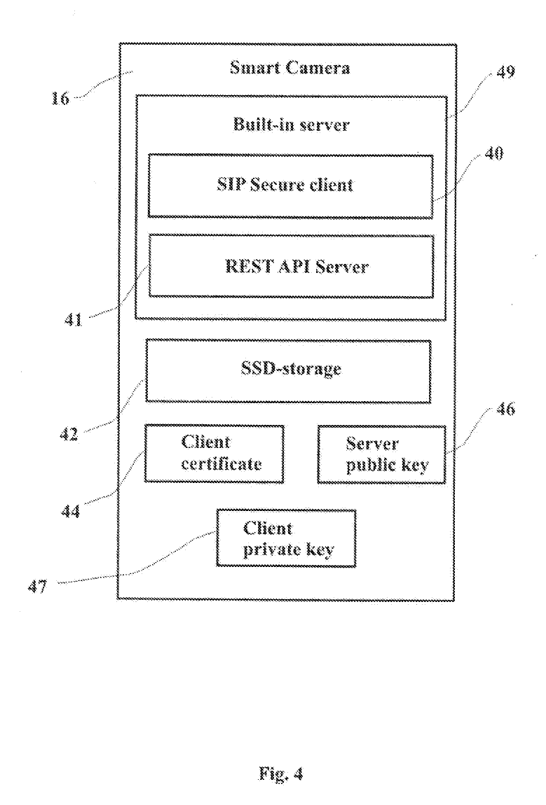

### THE FIELD OF THE INVENTION

The present invention concerns systems and methods of the secure control of smart camera and media content (video- and audio content, images) transfer from and/or to the smart camera. The system includes a smart camera, an intermediate server and user communication device. The secure control and transfer of video- and audio content in open networking such as Internet are realized with secure protocols (SIP Secure, SRTP, ZRTP, HTTP Secure). Additionally, a possibility to realize secure link from the smart camera to the user communication device on the base of “point-to-point” principles, without tunneling of media content and/or other information by means of the intermediate server is included in the interests of security of users.

### PRIOR ART

There exist on the market a plurality of wireless pan-tilt-zoom IP-cameras that enable housing monitoring to provide security functions, for disabled and aged people, patients, children, pets, or are intended for image recognition (identification numbers of automobiles, faces, people behavior, etc.) that have enhanced hardware with video analytics. Many of the IP-cameras have an internal computer for processing, compressing, storing and transmitting video- and audio content, image recognition, embedded storage, built-in server for providing network connections and video and voice over IP (VVoIP) services. Some of the cameras may have a rotating mechanism and zooming function, microphones for recording audio signals, and a possibility to send notification about threats via Internet.

The most of the internet protocols (IP) cameras existing currently in the market and transmitting users' personal information, such as video recording, by means of the internet, use an insecure network protocols HTTP, RTP, SIP, that bring to leaks of confidential and personal data and allows intruders to take control of IP-cameras.

Some of the IP-cameras include the support for secure protocol SRTP, that connects built-in servers of the IP-cameras to client application of the user device (e.g., smart phone, tablet PC) after appropriate authentication/authorization on base of the X.509 certificates, but the lack of interaction mechanism with a certificate issuers in ZRTP/SRTP protocols for identifying owners of certificates, generating, subscribing, and administering validity of the certificates, results in creation and usage of such a certification bodies as “web of trust”. Using the “web of trust” expose security vulnerabilities of the IP-cameras. Intruders could counterfeit client certificates and gain restricted access to user's personal data.

Other IP-cameras in order to provide access to video content and for controlling video cameras require user of the communication devices to enter an account and password. This method also has some faults, which enable intruders to take control of the IP-camera. Particularly, users' accounts and passwords may be eavesdropped in time of entering and transmitting through wired or wireless network. In case of lack of a built-in server in wireless IP-camera, and additional securing data, information may be captured by means of eavesdropping the wireless network, because connection protocols WEP and WPA don't have enough cryptographic security, or have internal vulnerabilities. WPA2 is more secure, but has been cracked also.

The invention subject matter of the present application relates to a unique and innovative system and methods of secure control of smart camera and media content transfer (video- and audio content, images) from and/or to the smart camera, designed to provide a solution to the problems described above efficiently and conveniently.

### LIST OF DRAWINGS

The drawings attached to the application are not intended to limit the scope of the invention and the manner of its implementation. The drawings are designed only to visualise the invention and constitute one option among many others for its implementation.

Drawing 1 describes schematically an example network in which systems and/or methods described herein may be implemented

Drawing 2 describes schematically an intermediate server (10) of the network illustrated in Drawing 1

Drawing 3 describes schematically an example user communication device (14) of the network illustrated ire Drawing 1

Drawing 4 describes schematically a smart camera (16) of the network illustrated in Drawing 1

### DETAILS OF THE INVENTION

The following detailed description refers to the accompanying drawings. The same reference numbers in different drawings may identify the same or similar elements.

The objective of the present invention is to provide a system and methods for securely controlling a smart camera (16) and/or transfer media content (herein video- and audio System of secure control of and media content (video- and audio content, images) transfer from and/or to the smart camera (16) includes of a built-in server (49) of the smart camera (16), an intermediate server (10) on WAN (may include of metropolitan area networks, the intranets, the Internet, etc.), and client applications (33) that are installed on the user communication devices (e.g. smart phone, tablet PC, laptop, etc.). Secure control and transfer of video- and audio content in open networking such as Internet is realized with secure protocols (SIP Secure, SRTP, ZRTP, HTTPS, etc.) that transfer data in use intermediate server PKI (public key infrastructure) (26) and private key (25), client certificates (44), server certificate (27), server public key (46) and/or client private key (47) that are built-in server (49) of smart cameras, server public key (34) of the user communication devices (14), to authorize/authenticate on intermediate server (10) as a user of a particular smart camera (16) or communication device (14). Additionally, in the interests of security of users, included a possibility to realize link from smart camera (16) to the user communication device on the base of principles “point-to-point”, without tunneling of media content via intermediate server (10) is included.

Systems and/or methods described herein may provide secure control of a smart camera (16) by one or more user communication devices (14) and/or transfer media content (herein video- and audio content) from a smart camera (16) to one or more user communication devices (14) and/or the intermediate server (10). For example, the systems and/or methods may enable a user of a communication device (14) to receive an overview of the smart cameras (16) that are connected to the local area network (LAN) (15) and/or wide area network (WAN) (13), an overview of home devices that are connected to the particular smart camera (16) via wireless network (e.g. Wi-Fi, Bluetooth, Zig-Bee, etc.), a list of Video and voice over IP (VVoIP) service users that are active/inactive on WAN (13) for providing access via VVoIP service or for teleconferencing, and overview of different telephone circuits (12) to call particular users of a telephone circuit (12). The user may drill down the menu to the particular smart camera (16), or may directly connect to the particular VVoIP user, or may view the different telephone circuits (12) and/or to connect with the particular VVoIP service user or selected telephone circuit (12). The user may select one of the smart cameras (16), and the systems and/or methods may display details associated with the selected smart camera (16) and display on one of the user web-browsers of the user device (14) video- and audio content from the smart camera (16). The systems and/or methods may also enable the user to control the operation of the selected smart camera (16), or to control the operation of the home devices that are connected to the smart camera (16) via wireless networks. Also, the user of the communication device (14) may select one of the active users of VVoIP-servers (11) and/or connect with the selected user, or may select one of the available telephone circuits (12) and call on particular telephone number.

As used herein, the term “user” it intended to be broadly interpreted to include a user communication device or a user of a user's communication device.

The basic components of the system: The pan-tilt-zoom (PTZ) IP camera on a hardware platform that is the object of control shall be referred as the “Smart Camera” (16). The system comprises of the following central components: one or more smart cameras (16), intermediate server (10), and one or more user communication devices (14), that are may be connected to WAN (13). Smart camera (16) and the user communication device may be connected to a LAN (15), that is of wired and/or wireless networks and/or communicating to WAN (13), and/or are connected to cellular networks (102) (e.g., GSM, GPRS, EDGE, WCDMA, LTE, etc.). Furthermore, the system may include a TV Set (19) with one or more different types of modules of wireless network (e.g., Zig-Bee, Bluetooth, etc.), a personal computer (18) with a monitor and/or audio outputs, and/or any other home devices that are connected to LAN (15) with the connected smart camera and/or directly to the smart camera (16) via any types of wireless network connections. In addition, the system may include VVoIP servers (11) that provide VVoIP-services and that are connected directly to the intermediate server (10), and/or to one or more telephone circuits (12), and/or one or more cellular networks (102), and/or have communication with one or more other VVoIP servers (11). System may include an third-party cloud server (17) to store media content, one or more cellular networks (102) that may provide access to WAN (13) for user communication devices (14) and/or the smart cameras (16).

The intermediate server (10) comprises of a SIPS-server (Session Initiation Protocol Secure Server) (21), a RTSP-Server (Real-Time Streaming Protocol Server) (22), a REST API Server (Representational State Transfer API Server) (23) and the cloud storage (24), that can securely communicate with other electronic devices connected to a common WAN (13) using the intermediate server Public Key infrastructure (26). private key (25) and server certificate (27). The SIPS-server (21) can receive and send SIPS packets. The RTSP-Server can communicate with particular smart camera (16) via SIPS protocol and retransmitting video- and/or audio content from selected smart camera (16) (in format of SIPS protocol) to one or more of the user communication devices (14) over RTSP protocol. REST API Server (23) can receive and send REST packets that are encapsulated inside of HTTPS (Hypertext Transfer Protocol Secure) packets. The cloud storage (24) of the intermediate server (10) can store video- and audio content received from the smart cameras (16) and/or other information, ad lib. RTSP-Server, SIPS-server, REST API Server and cloud storage may be allocated on the different physical servers, and/or connected to the different physical networks, but they all must be logically integrated as intermediate server.

The S art Camera (16) comprises a built-in server (49) and a SSD-storage (Solid State Drive Storage) (42), a client certificate (44), a client private key (47) and intermediate server public key (46). The built-in server (49) comprises of a SIPS-client (Session initiation Protocol Client) (40), and a REST API Server (Representational State Transfer API Server) (41). The SIPS-client (40) can send SIPS packets. The REST API Server (41) can send and receive secure REST-requests to and/or from user communication devices (14) and/or the intermediate server (10). SSD-storage (Solid State Drive Storage) (42) can store video- and audio content, that may be recorded on SSD-Storage (42) in particular compression format (e.g., MPEG, MPEG-2, AAC, etc.) of video- and audio streams. The media content may be received from user communication devices (14), the video camera of the smart camera (16), the microphones of the smart camera (16), cloud storage of intermediate server (10), third-party cloud server (17), or other electronic devices that connected via Internet protocols of the WAN (13) or the common LAN (15) to the smart camera (16).

The user communication device (14) includes a user interface (30), a client application (33) to interact with the intermediate server (10) and smart cameras (16) and public key of intermediate server (34). The client application (33) comprises of SIPS-client (Session Initiation Protocol Secure Client) (31), and a REST Client (Representational State Transfer Client) (32). The REST Client (32) can receive and send REST-requests, encapsulated inside of secure HTTPS packets. The SIPS-client (31) can receive and send SIPS packets to the intermediate server (10) and/or user communication devices (14).

The Communication Manner of the System Components:

In one example communication, that is intended on secure control of and transfer media content from and/or to one of the smart cameras (16), the user communication device (14) is connected to wireless communication (e.g., Wi-Fi, EDGE, GPRS, WCDMA, LTE, etc.) and has user interface (30) that may comprise of mechanism for inputting information to the user communication device (14) and outputting information on. The user via the user's interface (30) gets information about smart cameras, and may select one of the particular smart cameras that are displayed in the user interface (30). The REST-client (32) of the client application (33) sends the defined REST-request to the intermediate server (10). The server (10) authenticates and authorizes the user communication device and the smart camera (16).

The authentication data in the described communication comprises of the smart camera (16) that includes certificate (44) and private key (47) (both assigned during manufacturing), smart camera authorization token, that is assigned and transmitted to user communication device (14) when user connects to smart camera for a first time, intermediate server certificate (27) and private key (25), server public keys (34) (46).

The authentication and authorization in the described communication comprises of:

intermediate server's certificate (27) (with server public key) used to authenticates and authorizes REST and SIPS connections from intermediate server (10) by smart camera (16);

smart camera's authorization token used to authenticate and authorize REST and SIPS connections from user communication device (14);

intermediate server (10) verifies the user's communication device identity by user's login and password hash, assigning and transmitting a temporary authorization token, wherein, if a temporary user's authorization token expires, user communication device (14) must re-request another authorization token using re-authenticating user's login and password hash; smart camera's certificate (44) used to authenticate and authorize REST and SIPS connections from smart camera (16) by intermediate server (10);

user's authorization token used to authenticate and authorize REST and SIPS connections from user communication device (14) by intermediate server (10);

user communication device authenticates and authorizes REST messages from a REST API Server (23) of intermediate server (10) or a REST server (41) of smart camera (16) using their certificates (27) (44);

user communication device authenticates and authorizes SIPS connections from SIPS clients (31) (40) via SIPS Server (21) of intermediate server(10) authentication.

When a user of the communication device requests the information about the connected smart cameras, the REST-client (32) sends a secure REST-request (encapsulated inside of HTTPS packets) to the intermediate server (10) about active smart cameras (16). The intermediate server (10) then sends REST-requests to the selected smart camera (16). The REST API Server (41) of the smart camera (16) that received the defined REST-request from the intermediate server (10) sends requested information (e.g., active/inactive status of video camera, tilt/pan angles, power-supply status, etc.) to intermediate server (10) in response. Intermediate server (10) receives and saves information from the smart camera associated with the user communication device (14), and sends information wholly or partially to the user communication device (14).

After that the intermediate server (10) initiates a SIPS connection between SIPS Client (40) of the smart camera (16) to SIPS Client (31) of the user device (14), Such SIPS connection may be realized with tunneling SIPS packets via Intermediate server (10), ad lib. After initiation SIPS transfer, the video- and/or audio stream from the smart camera (16) may be displayed on one a the web-browsers of the user device (14).

User of a communication device (14) can control (e.g., a pan-tilt-zoom functions, take photos/record videos, etc.) the selected smart camera (16) by means of REST protocol. Additionally, the user of communication device (14) has a possibility to record media content wholly or partially from video camera of the smart camera (16) on the SSD-storage (42) of the smart camera (16).

The user communication device (14) and the smart camera (16) can communicate directly, without the intermediate server (10), if the smart camera(16) is reachable over network (for instance, not behind a NAT or firewall).

In further embodiment of the present invention, the user of smart camera (16) defines the smart camera as the “public” and saves public status on the intermediate server (10). In this manner, the REST-client (32) sends a REST-request (over HTTPS) to intermediate server (10) about active public smart cameras (16). The intermediate server (10) sends particular REST-requests to all public smart cameras (16). The public smart camera (16) that received the REST-request from the intermediate server (10), sends the requested information (e.g., active/inactive status, tilt/pan angles, etc.) to the intermediate server (10) in response. The intermediate server (10) receives information from all public smart cameras and sends information wholly or partially to the user communication device (14).

The user of communication device (14) can enter to one of the available public smart cameras (16). Thereafter, the REST-client (32) of the user communication device (14) sends a REST-request (secured by HTTPS protocol) to the intermediate server (10) for connecting with the selected public smart camera (16). RTSP Server (23) initiates SIPS-connection with SIPS-Client (40) of the selected public smart camera (16). After that, video- and audio content(in particular compression format) that was received from the selected public smart camera and encapsulated in RTSP-packets by means of the Server RTSP (22), transferring to the user communication device (14).

One or more users of communication devices (14) can obtain control functions and/or media content from the public smart camera (16) over RTSP protocol. If another user of communication device (14) sends REST-request to intermediate server (10) on the public smart camera (16) that is used in any other user communication device (14), the intermediate server (10) doesn't initiate new SIPS-connection with the public smart camera (16). Instead of initiation new SIPS connection the RTSP Server (22) starts transferring media content that is already received from the smart camera (16) to the new user communication device (14).

At a moment when all the users of communication devices (14) become disconnected from the public smart camera (16) RTSP Server (22) also breaks SIPS connection with SIPS-client of the smart camera (16).

In yet another communication a smart camera (16) and a user communication device (14) are connected to a common LAN (15), the smart camera (16) may be used as an external wireless video and audio device for realizing VVoIP (Video and voice over IP) connection with any other user communication devices (14), or to overview place where the smart camera (16) is located. In this case, the smart camera (16) also may be used for photographing and/or video- and/or audio recording and for saving received images and video- and audio content on the SDD-store (42), or the cloud storage (24) of the intermediate server (10).

The user of communication device (14) that is connected to common LAN (15) with the smart camera (16) using user interface (30) that may include mechanism to input and output information, activates the menu item of the user interface (30) “connect with the smart camera”. The REST-client (32) sends a secure REST-request (encapsulated inside of HTTPS packets) to the intermediate server (10) and/or directly to built-in server (49) of smart camera (16) connected on common LAN (15).

If one or more of the smart cameras (16) are connected to the common LAN (15) with user communication device (14), the smart cameras (16) come into the REST-connection (inside of secure HTTPS) directly with the user communication device (14).

The authentication data in the described communication comprises of the smart camera (16) that includes certificate (44) and private key (47) (both assigned during manufacturing), smart camera authorization token that is assigned and transmitted to user communication device (14) when user connects to smart camera for a first time.

The authentication and authorization in this communication (devices connected to common LAN) comprises of:

smart camera's authorization token used to authenticate and authorize REST and SIPS connections from user communication device (14);

smart camera's certificate (44) used to authenticate and authorize REST connections from REST Server (41) of smart camera (16) by user communication device (14);

When a smart camera (16) and a TV Set (19) are connected to a common LAN (15), the display of the TV Set (19) may be used as an external monitor for realizing VVoIP (Video and voice over IP) connection with any other user communication devices (14), or streaming media content from SSD-storage (42), and or cloud storage (24) of the intermediate server (10), and/or third-party cloud server (17), Network interaction between the smart camera and the TV Set may be realized by means of secured wireless screencasting protocol, such as Miracast, AirPlay, or other.

TV Set (19) is a television set that may include DVD- and/or Blu-Ray player, set-top box, hybrid box, internet protocol television (IPTV) receiver, home theater, HDTV receive or other receivers, and where the smart camera may transfer video- and/or audio content to TV directly or by means of the listed above TV connected devices.

Otherwise, media content may be streamed to monitor and audio outputs of a personal computer (18), that is connected to common LAN (15) with the smart camera (16). The interaction between the smart camera (16) and the personal computer (18) may be realized by means of the secure networking protocols. The smart camera (16) is controlled by the user communication device (14) associated with the smart camera (16).

It a smart camera (16) and a user communication device (14) are already connected to each other via REST-protocol, the user of the device (14) may request information from the intermediate server (10) about other active user communication devices (14). Requested information may be displayed on the user interface (30). After that, the user of communication device (14) can select and connect to one of the other active user communication devices (14). The REST-client (32) of the client application (33) sends the defined REST-request to the smart camera (16). Thereafter, the REST API Server (41) of the smart camera (16) sends REST-request to the intermediate server (10). The server (10) authenticates and authorizes the smart camera (16) and another user device (14) in accordance with PKI (26), that is stored on, the server public key (34) (46) and the client certificate (44) and/or client private key (47). If the smart camera (16) and another user device (14) successfully passed authentication and authorization, intermediate server (10) transfers (inside of secure protocols SRTP/ZRTP) temporary public keys to the smart camera (16) and the another user communication device (14). After that the intermediate server (10) initiates a SIPS connection from the SIPS Client (40) of the smart camera (16) to the SIPS Client (31) of the another user device (14), for transferring video- and audio content to the another u communication device (14), and contrariwise. During two-way SIPS-transmission both of the users may have possibility to control the smart camera (16) wholly or partially, if permitted by the user communication device (14) that is associated with the smart camera (16).

In addition, the users of the communication devices (14) that have passed authentication/authorization and have access to the intermediate server (10), or the users communication devices (14) where the smart camera (16) is used as an external wireless ides camera and/or microphone, can realize SIPS connection via intermediate server (10) with other users of Video and voice over IP services of the VVoIP-servers (11) that have secure IP-tunneling to the intermediate server (10). The users of the communication devices (14) with or without the smart camera (16) that have passed authentication/authorization can call on particular telephone number in one of the available telephone circuit (12) or available cellular network (102) that are witching to the VVoIP-servers (11) that are connected by secure IP-link to the intermediate server (10).

1. A system of secure control of a smart camera and/or secure transfer a media content from and/or to the smart camera by a user communication device and an intermediate server, comprising:
one or more smart camera, intermediate server, and one or more of user communication device, that are all connected to WAN;
wherein the intermediate server includes a SIPS-server, REST API Server, cloud storage, Public Key Infrastructure (PKI) and private key;
wherein the smart camera includes a built-in server, a SSD-storage, a client certificate, client private key and an intermediate server public key;
wherein said built-in server includes a SIPS-client and REST API Server;
wherein said user communication device includes a SIPS-client, a REST Client and a public key of said intermediate server;
wherein one or more of said smart cameras and one or more of said user communication devices may be connected to common local area networks (LAN), that include of wired and/or wireless networks and/or communicating to wide area network (WAN), and/or are connected to cellular networks;
wherein the smart cameras may be connected to one or more of home devices via any types of wireless network connections;
wherein the intermediate server may be securely connected directly or via WAN to VVoIP server, that may be connected to one or more of telephone circuits and/or a cellular networks.

2. The system described in claim 1, wherein it is also includes a TV Set connected to a wireless network, and said smart camera streams a video- and/or audio content received from one or more of any other users of said intermediate server and/or said users of the VVoIP servers to TV Set by means of wireless network connection.

3. The system described in claim 1, wherein it is also includes a personal computer with a monitor and/or audio outputs that has wireless or wired access to common LAN, and the smart camera streams a video- and/or audio content received from one or more any other users of the intermediate server and/or the users of the VVoIP servers to monitor and/or audio outputs of the personal computer.

4. The system described in claim 1, wherein it is also includes a third-party cloud server connected to WAN to store media content, and the users of the communication devices that are associated with said smart cameras have possibility to save media content and/or other information directly to storage of a off-site cloud server, and/or download media content and/or other information to the smart camera and/or the user communication device that is associated with one or more said smart cameras.

5. A network protocol and device-implemented method of secure control of a smart camera by a user communication device, comprising:
securely requesting the information associated with the particular smart camera by the user communication device from the intermediate server, if required;
securely receiving an actual information about the smart camera that is associated with the user communication device and based on the intermediate server data by the user communication device, or secure receiving the actual information directly from the smart camera;
generating control commands to the particular smart camera that is associated with the user communication device by the user communication device;
securely transmitting the control commands from the user communication device to the particular smart camera via the intermediate server or directly on the base of “point-to-point” principles.

6. A network protocol and device-implemented method of providing media content secure transmission between the user communication devices and the smart cameras, comprising:
initiating direct secure connection with one or more smart cameras that are associated with particular user communication device by the user communication device;
initiating secure connection with one or more user communication devices that are associated with particular smart camera on the smart camera initiative by the means of the intermediate server;
direct secure network media content transmission between the user communication device and one or more smart cameras;
direct secure network media content transmission between the smart camera and one or more user communication devices.

7. A network protocol and device-implemented method of providing secure interaction between a user communication device and a smart camera by means of the intermediate server, comprising:
authentication and authorization on the intermediate server for each of the plurality of the user communication devices and the smart cameras based on received client certificates of the smart cameras and “login-password” pairs by the user communication devices;
initiating secure connection between one or more of the plurality of the user communication devices and one or more of the plurality the smart cameras after authentication and authorization on intermediate server;
initiating after authentication and authorization on the intermediate server secure connection between one or more of the plurality of the user communication devices and/or one or more of the plurality of the smart cameras with any available users of the VVoIP-servers that have commutate link with the intermediate server;
initiating after authentication and authorization on intermediate server secure connection between one or more of the plurality the user communication devices or one or more of the plurality the smart cameras with the telephone circuits or the cellular networks, that have commutate link with intermediate server, for calling on particular telephone number;
secure network media content transmission between one or more of the user communication devices and one or more of the smart cameras;
secure connection one or more of the plurality the user communication devices and/or one or more of the plurality the smart cameras with any available users of the VVoIP-servers that have commutate link with intermediate server;
secure connection one or more of the plurality of user communication devices and/or one or more of the plurality of the smart cameras with particular telephone circuits or the cellular networks that have commutate link with the intermediate server, for calling on particular telephone number;
transmitting and saving on the secure cloud storage of the intermediate server a media content and/or other information from the smart cameras and/or the user communication devices that is associated with the smart cameras;

8. A network protocol and device-implemented method of providing the secure network interaction between a user communication device and a smart camera that are connected on common LAN, by means of the built-in server of the smart camera, comprising:
generating and transmitting security token to the user communication device by the smart camera, if required;
authentication and authorization of one or more of the user communication devices that are associated with the smart camera on the built-in server of the smart camera based on received from the user communication device code sequence;
initiating secure connection between one or more of the user communication devices and the smart camera after authentication and authorization user communication devices on built-in server of the smart camera;
secure network transmission media content between one or more the user communication devices and the smart camera;
saving on the secure storage of the smart camera a media content and/or other information received from a video camera and/or the microphones of the smart camera, and/or generated information by the built-in server, and/or received media content from the user communication devices associated with the smart camera;

9. A device-implemented method of providing secure network interaction between the user communication device and the smart camera of claim 8, wherein smart camera is streaming a video- and/or audio streams received from one or more any other users of the intermediate server to TV Set by secured wireless screen casting protocol, such as Miracast, AirPlay, or other.

10. A device-implemented method of providing secure network interaction between the user communication device and the smart camera of claim 8, wherein the smart camera is used as an external wireless video camera and/or microphone, and the user of the communication device associated with the smart camera can realize VVoIP connection via intermediate server with available users video and voice over IP services of the other VVoIP-servers that have secure link to the intermediate server.

11. A device-implemented method of providing secure network interaction between the user communication device and the smart camera claim 9, wherein the smart camera is used as an external wireless video camera and/or microphone, and the user of the communication device associated with the smart camera can realize VVoIP connection via the intermediate server with users of the any other VVoIP-servers that have secure link to the intermediate server.

12. A device-implemented method of providing secure network interaction between the user communication device and the smart camera claim 9, wherein the smart camera is used as external wireless video camera and/or microphone, and the user of the communication device associated with the smart camera can call on particular telephone number via one of the available telephone circuits or cellular networks that is switching by secure link to the intermediate server.
